(19) United States
(12) Patent Application Publication
(10) Pub. No.: US 2009/0102231 A1
(43) Pub. Date: Apr. 23, 2009

(54) Recreational vehicle with expandable living area

(76) Inventor: Itty Atcravi, San Diego, CA (US)

Correspondence Address: Itty Atcravi, P.O. Box 721899, San Diego, CA, 92172-1899, US

(21) Appl. No.: 12/316,773

(22) Filed: Dec. 15, 2008

Related U.S. Application Data
(62) Division of application No. 11/043,535, filed on Jan. 26, 2005, now abandoned.
(60) Provisional application No. 60/539,759, filed on Jan. 27, 2004.

(51) Int. Cl. B60P 3/34

(52) U.S. Cl. 296/175

(57) ABSTRACT

A recreational vehicle comprising a driver's compartment (101) containing forward-facing seats (110, 111), a main coach section (102) connected to the rear end of driver's compartment (101), a retractable rearward-facing couch (151) extending from the front end of main coach section (102) into the space above forward-facing seats (110, 111), a retractable room extension in the form of a bedroom slide (104), and storage compartments (140, 145) which are movable out of main coach section (102) into bedroom slide (104) when bedroom slide (104) is in its extended position.

### CROSS-REFERENCE TO RELATED APPLICATIONS

This is a division of patent application Ser. No. 11/043,535, filed 2005 Jan. 26 which claims the benefit of provisional patent application Ser. No. 60/539,759, filed 2004 Jan. 27 by the present inventor.

### BACKGROUND-FIELD

This application relates generally to recreational vehicles such as motor homes and travel trailers and specifically to self-contained motor homes with an expandable living area.

### BACKGROUND-PRIOR ART

The most difficult challenge in designing and building a small motor home has always been to provide as many desirable amenities as possible in a one-story vehicle that is small enough to be parked almost anywhere. In particular, what most people would like to have but have so far been unable to obtain is a one-story motor home which can be parked in most public parking spaces and includes a couch, a dinette, a kitchen with a double sink, a stove and a refrigerator, a bathroom with a shower stall or a bathtub, a sink and a toilet, a large open space in the living area, and plenty of room for storage, as well as a walk-in bedroom instead of or in addition to an over-the-cab (“cabover”) bed.

Various types of recreational vehicle are known to have a living area which is expandable in the forward, rearward, sideways or upward direction when the vehicle is not being driven. For example, U.S. Pat. No. 2,343,261 to Marple (1944) shows a trailer which is expandable in the forward and rearward directions as well as in the upward direction. My U.S. Pat. No. 6,729,678 (2004) discloses multi-story recreational vehicles which are expandable sideways.

Other vehicles, such as those described in U.S. Pat. No. 3,879,081 to Hockley and Rizzi (1975) and Japanese Patent 11-123964 to Katsuaki and Narimichi (1999) have a driver's compartment which can be converted into a sleeping compartment with the use of a retractable bed or cushions.

U.S. Pat. No. 4,550,946 to Hanemaayer (1985) shows a motor home with a swingable coat rack mounted to pivot into and out of a shower stall. Movable partitions or folding doors are provided for dividing the interior of the motor home into two or three separate compartments including a privacy compartment which is basically a bathroom with the swingable coat rack and kitchen appliances inside.

However, these arrangements cannot be readily combined to create a motor home which is small enough to be parked in most public parking spaces and includes all of the amenities mentioned above.

### SUMMARY

In accordance with the present embodiments, space-saving features are provided to enable the motor home to be made substantially smaller without sacrificing any of the above-mentioned amenities. One of the space-saving features of the motor home is a retractable couch which can be folded and stored outside the driver's compartment while the vehicle is being driven. The couch can be extended over the front seats while the vehicle is at rest. This arrangement enables the motor home to be made substantially shorter than a similarly equipped motor home with a couch positioned adjacent to one of the vehicle's side walls. Another space-saving feature is a storage compartment which can be moved out of the main section of the motor home into a bedroom slide when the slide is in its extended position.

### DRAWINGS

### Figures

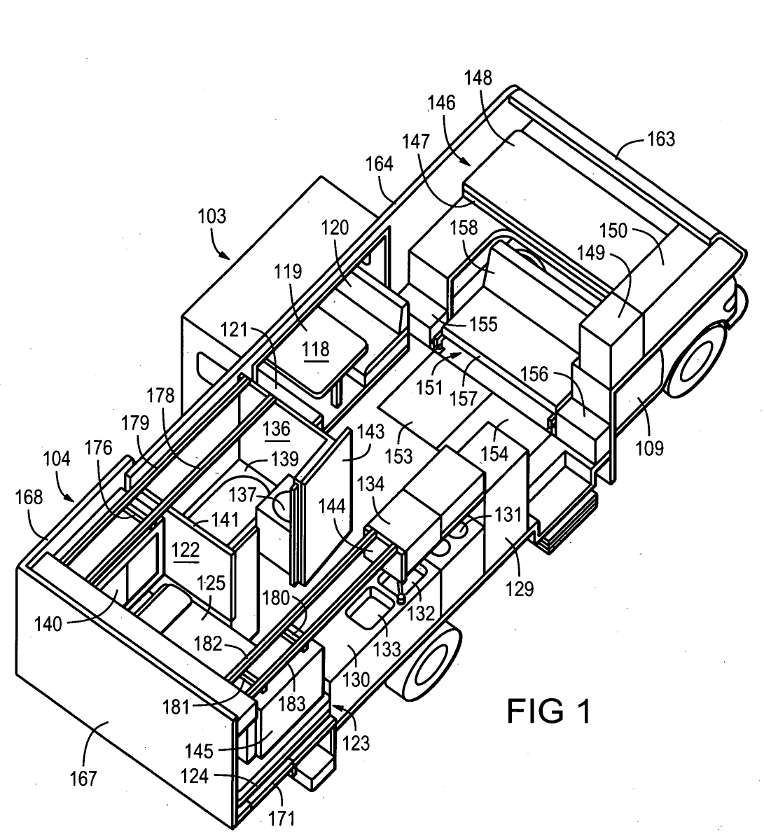

FIG. 1 is a perspective view of the first embodiment of a motor home with the right side wall, the right side panel of the bedroom slide, the roof and the top panel of the bedroom slide removed to show the interior of the vehicle.

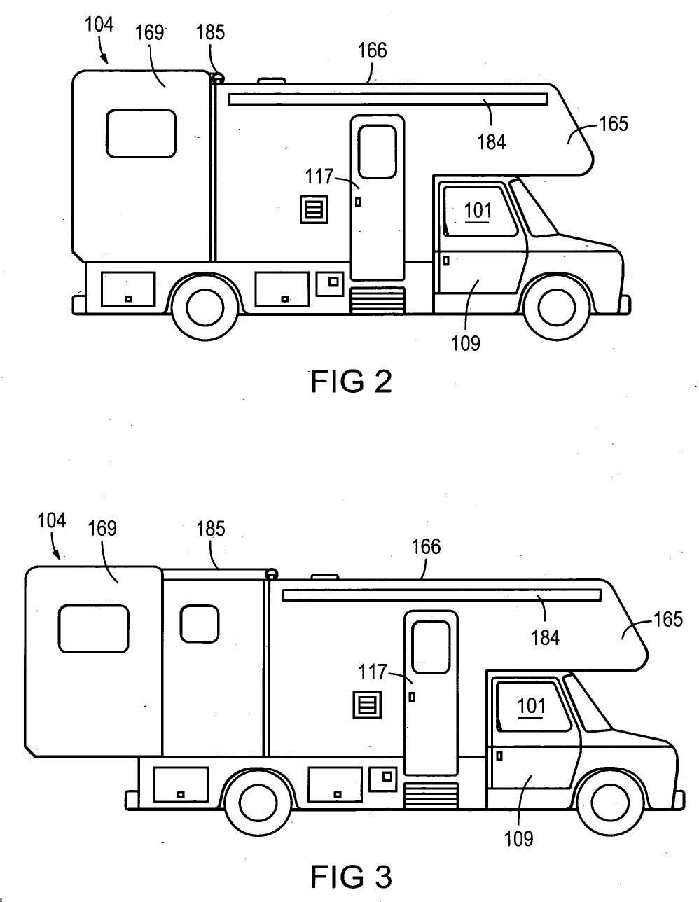

FIG. 2 is an external side view of the first embodiment with the bedroom slide retracted.

FIG. 3 is an external side view of the first embodiment with the bedroom slide extended.

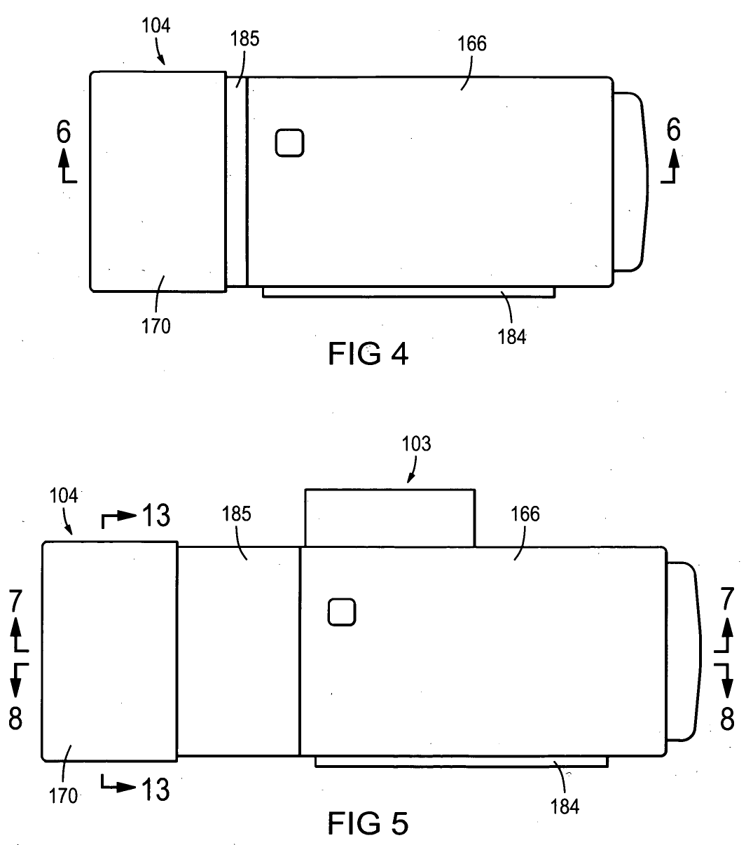

FIG. 4 is an overhead view of the first embodiment with both slides retracted.

FIG. 5 is an overhead view of the first embodiment with both slides extended.

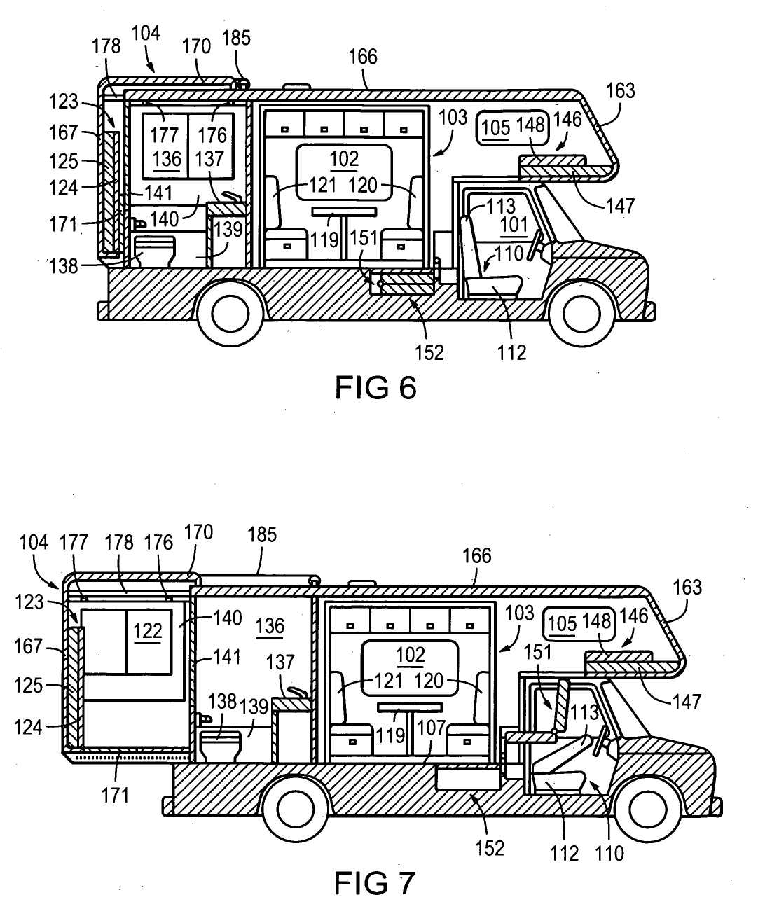

FIG. 6 is a sectional side view of the first embodiment taken along the line 6-6 in FIG. 4 with the bedroom slide retracted.

FIG. 7 is a sectional side view of the first embodiment taken along the line 7-7 in FIG. 5 with the bedroom slide extended.

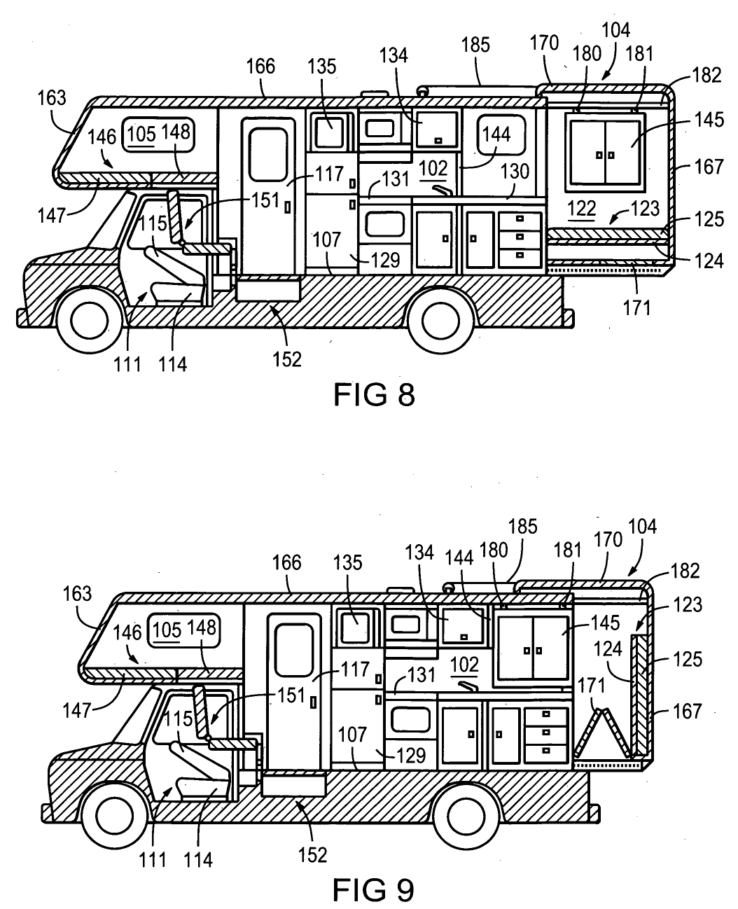

FIG. 8 is a sectional side view of the first embodiment taken along the line 8-8 in FIG. 5 with the bedroom slide extended.

FIG. 9 is a sectional side view of the first embodiment taken along the line 8-8 in FIG. 5 with the bedroom slide in an intermediate position.

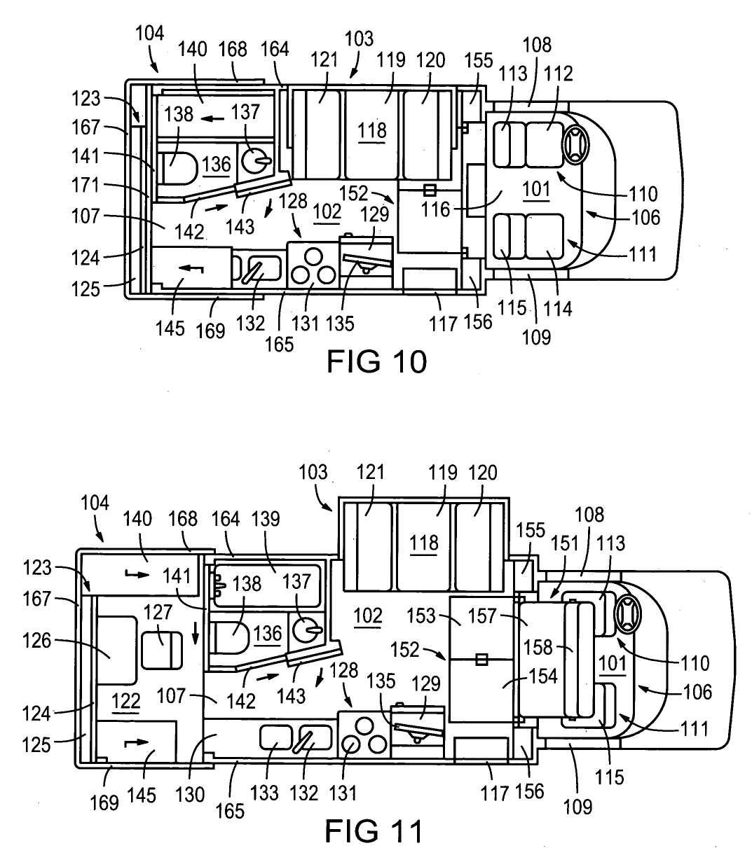

FIG. 10 is a floor plan of the first embodiment showing the driver's compartment and the portion of the main coach section behind the cabover compartment with both slides retracted.

FIG. 11 is a floor plan of the first embodiment showing the driver's compartment and the portion of the main coach section behind the cabover compartment with both slides extended, the bedroom arranged as an office, and the retractable couch in its extended position above the driver's and passenger's seats.

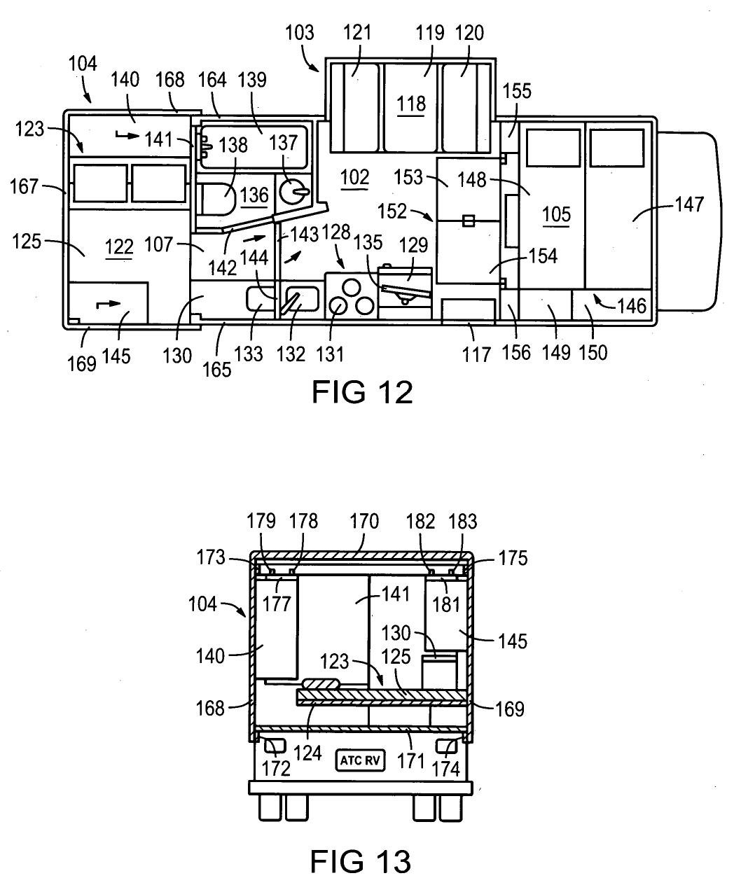

FIG. 12 is a floor plan of the first embodiment showing the main coach section including the cabover compartment with both slides extended and both the main bed and the cabover bed arranged for sleeping.

FIG. 13 is a sectional rear view of the first embodiment taken along the line 13-13 in FIG. 5 with the bedroom slide extended and the main bed arranged for sleeping.

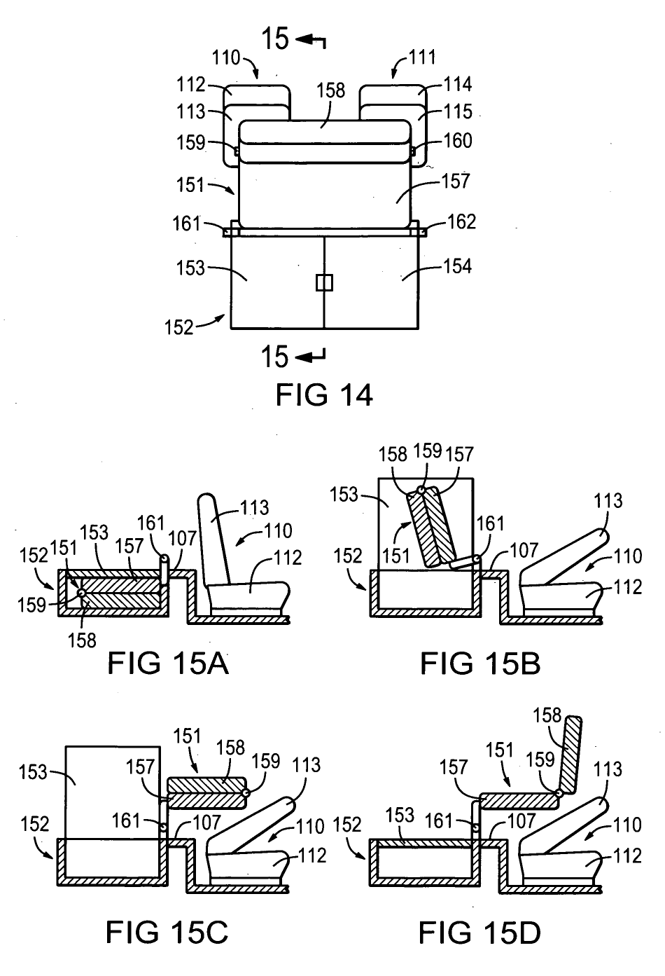

FIG. 14 is a top view of the retractable couch of the first embodiment in its extended position.

FIGS. 15A-15D are sectional side views of the retractable couch of the first embodiment taken along the line 15-15 in FIG. 14 showing four different positions of the couch.

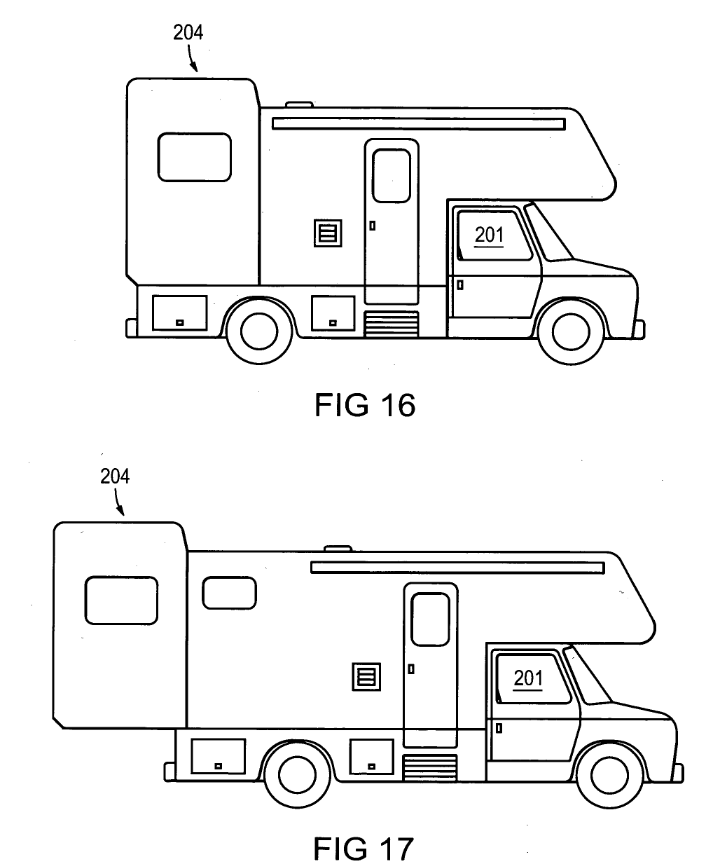

FIG. 16 is an external side view of a second embodiment with the bedroom slide retracted.

FIG. 17 is an external side view of the second embodiment with the bedroom slide extended.

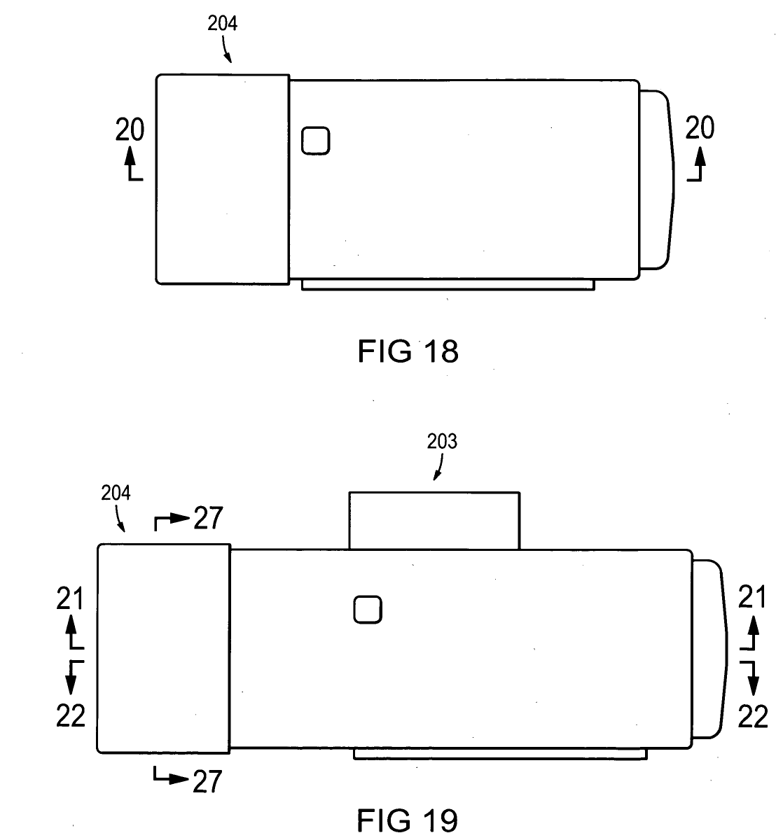

FIG. 18 is an overhead view of the second embodiment with both slides retracted.

FIG. 19 is an overhead view of the second embodiment with both slides extended.

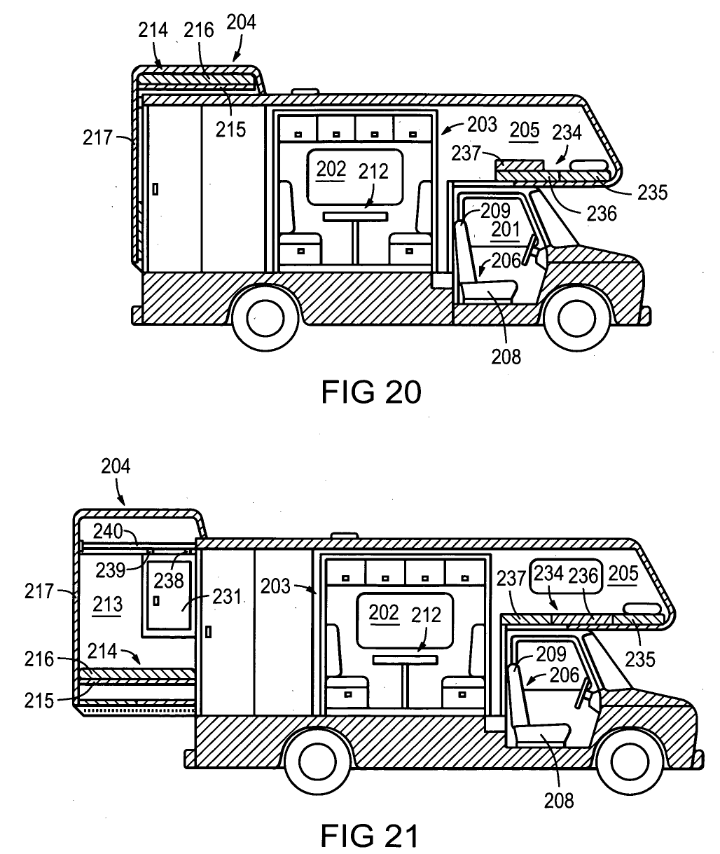

FIG. 20 is a sectional side view of the second embodiment taken along the line 20-20 in FIG. 18 with the bedroom slide retracted.

FIG. 21 is a sectional side view of the second embodiment taken along the line 21-21 in FIG. 19 with the bedroom slide extended.

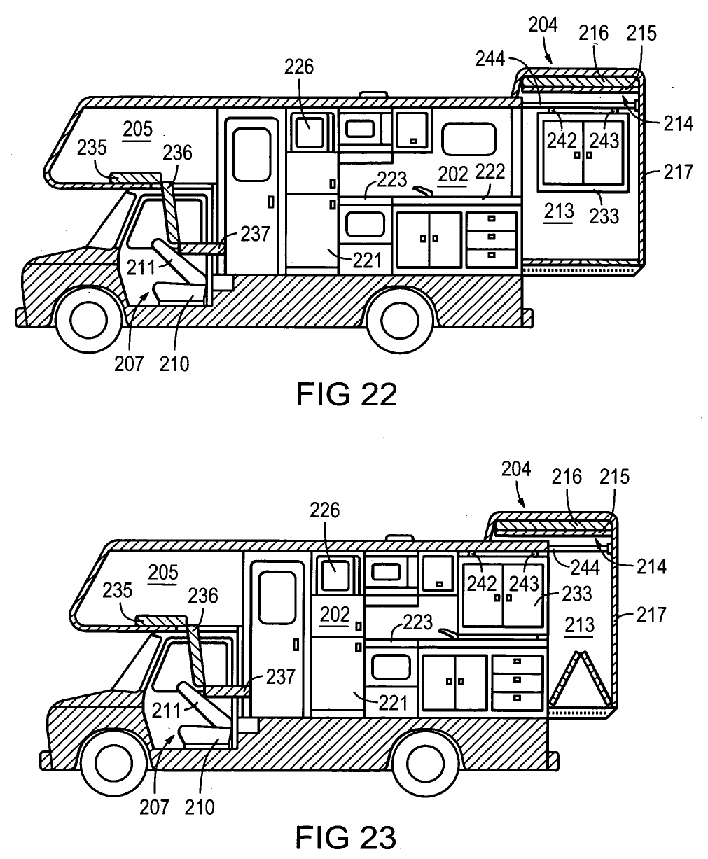

FIG. 22 is a sectional side view of the second embodiment taken along the line 22-22 in FIG. 19 with the bedroom slide extended.

FIG. 23 is a sectional side view of the second embodiment taken along the line 22-22 in FIG. 19 with the bedroom slide in an intermediate position.

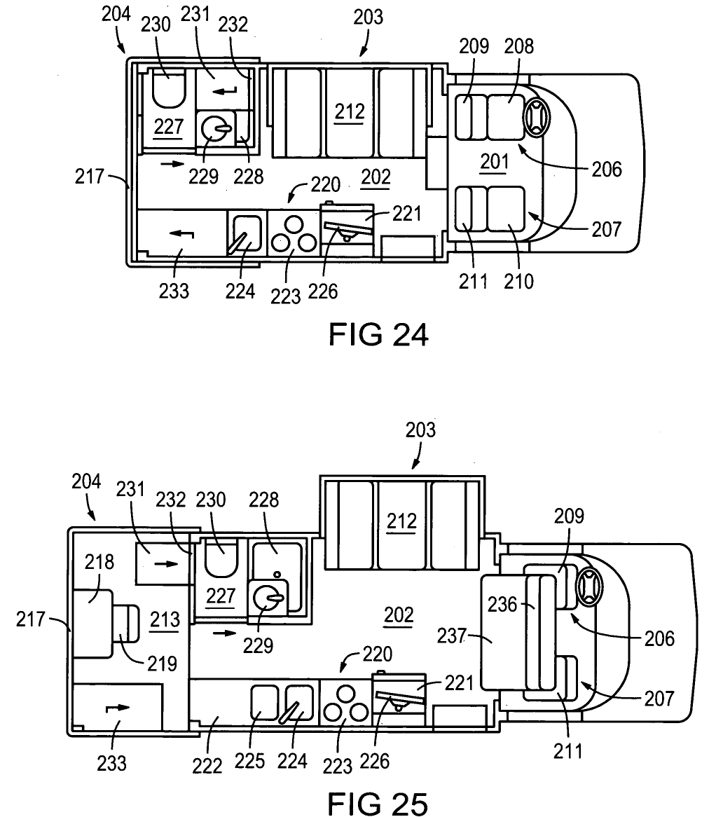

FIG. 24 is a floor plan of the second embodiment showing the driver's compartment and the portion of the main coach section behind the cabover compartment with both slides retracted.

FIG. 25 is a floor plan of the second embodiment showing the driver's compartment and the portion of the main coach section behind the cabover compartment with both slides extended, the rear bedroom arranged as an office, and the cabover bed converted into a couch.

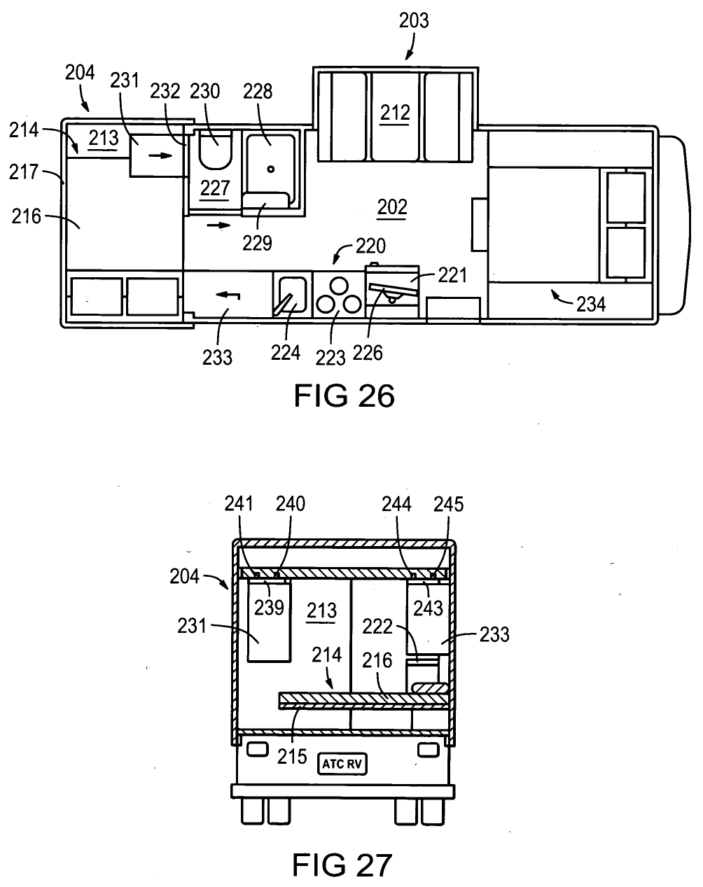

FIG. 26 is a floor plan of the second embodiment showing the main coach section including the cabover compartment with both slides extended and both the main bed and the cabover bed arranged for sleeping.

FIG. 27 is a sectional rear view of the second embodiment taken along the line 27-27 in FIG. 19 with the bedroom slide extended and the main bed arranged for sleeping.

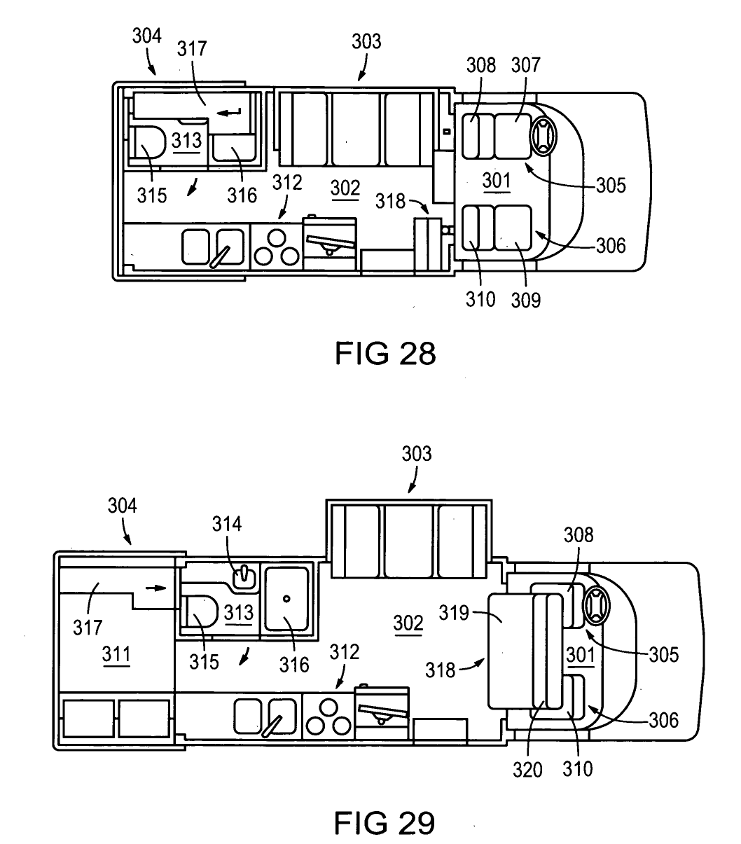

FIG. 28 is a floor plan of a third embodiment showing the driver's compartment and the portion of the main coach section behind the cabover compartment with both slides retracted and the retractable couch in its storage position.

FIG. 29 is a floor plan of the third embodiment showing the driver's compartment and the portion of the main coach section behind the cabover compartment with both slides extended, the main bed arranged for sleeping, and the retractable couch in its extended position above the driver's and passenger's seats.

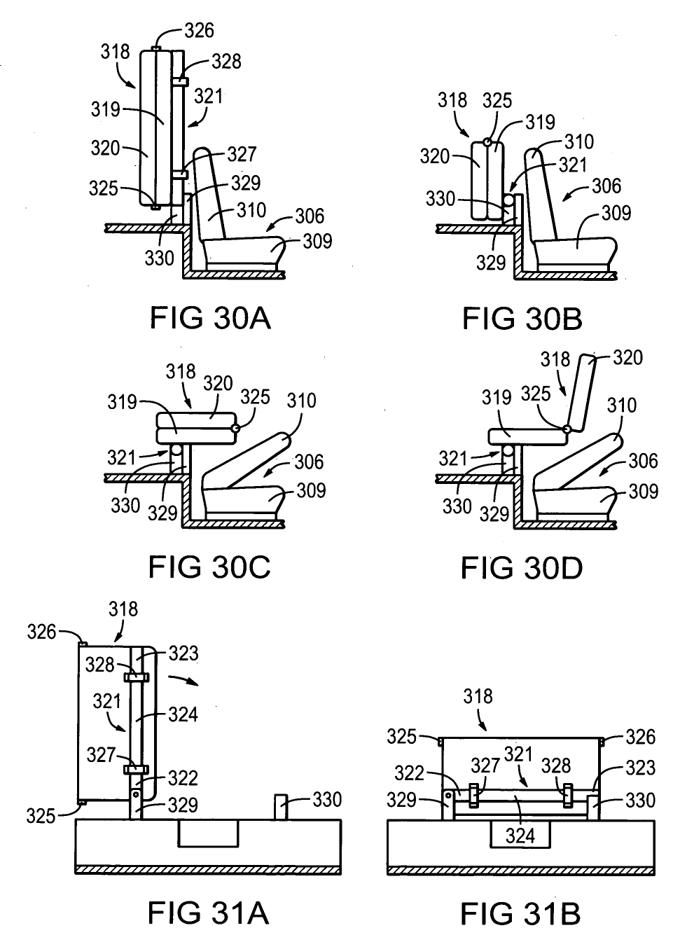

FIG. 30A-30D are side views of the retractable couch of the third embodiment showing four different positions of the couch.

FIGS. 31A and 31B are front views of the retractable couch of the third embodiment showing two different positions of the couch corresponding to the positions shown in FIGS. 30A and 30B.

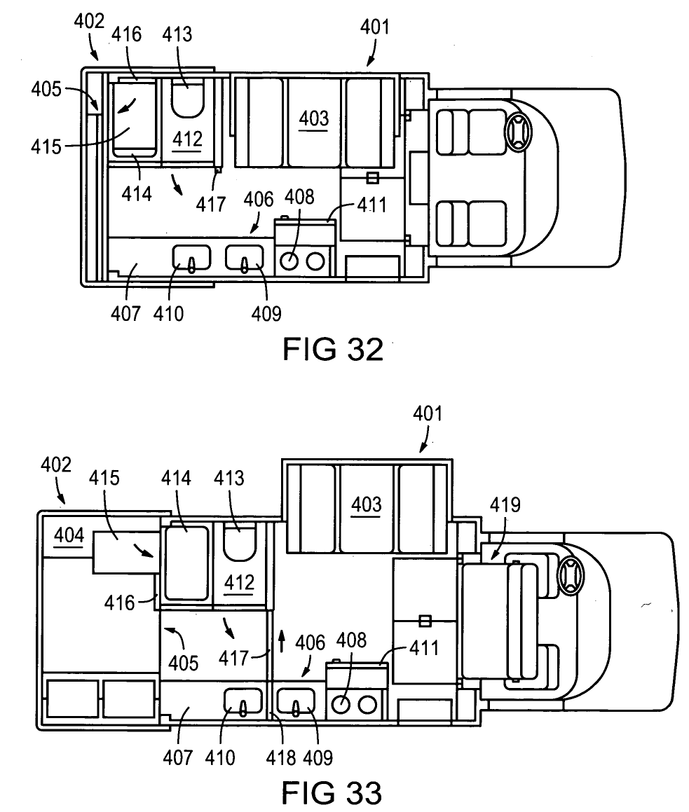

FIG. 32 is a floor plan of a fourth embodiment showing the driver's compartment and the portion of the main coach section behind the cabover compartment with both slides retracted.

FIG. 33 is a floor plan of the fourth embodiment showing the driver's compartment and the portion of the main coach section behind the cabover compartment with both slides extended, the main bed arranged for sleeping, and the retractable couch in its extended position above the driver's and passenger's seats.

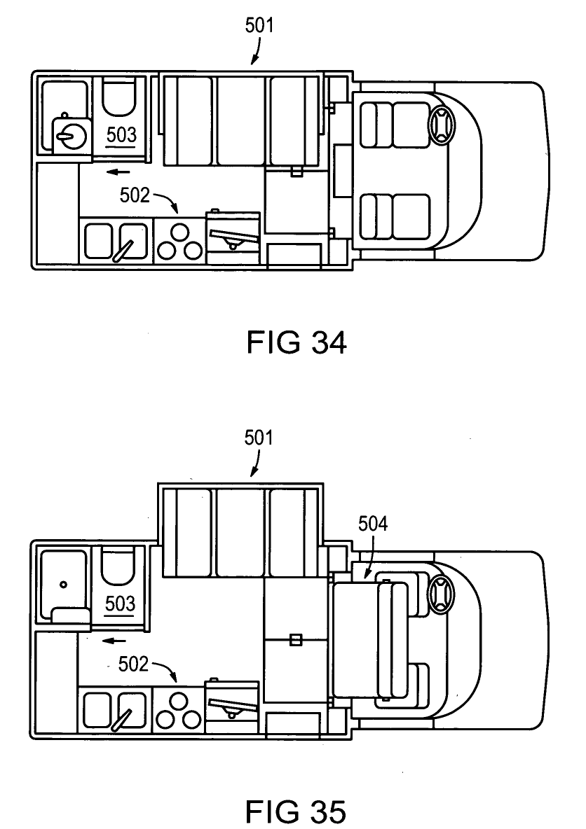

FIG. 34 is a floor plan of a fifth embodiment showing the driver's compartment and the portion of the main coach section behind the cabover compartment with the dinette slide retracted.

FIG. 35 is a floor plan of the fifth embodiment showing the driver's compartment and the portion of the main coach section behind the cabover compartment with the dinette slide extended and the retractable couch in its extended position above the driver's and passenger's seats.

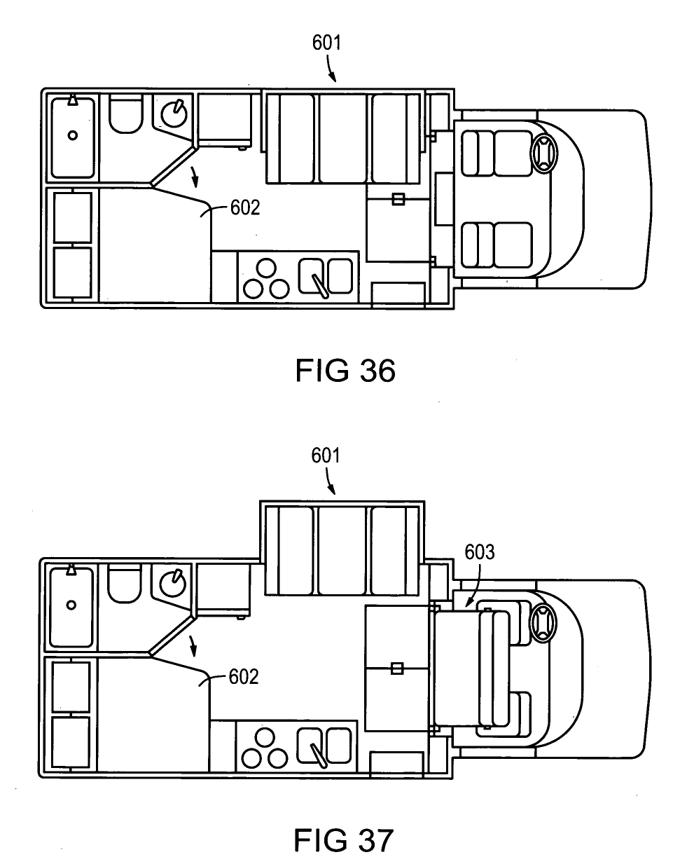

FIG. 36 is a floor plan of a sixth embodiment showing the driver's compartment and the portion of the main coach section behind the cabover compartment with the dinette slide retracted.

FIG. 37 is a floor plan of the sixth embodiment showing the driver's compartment and the portion of the main coach section behind the cabover compartment with the dinette slide extended and the retractable couch in its extended position above the driver's and passenger's seats.

### DRAWINGS

### Reference Numerals

101 driver's compartment
102 main coach section
103 dinette slide
104 bedroom slide
105 cabover compartment
106 floor of driver's compartment 101
107 main floor
108 left side door
109 right side door
110 driver's seat
111 passenger's seat
112 bottom part of driver's seat 110
113 backrest of driver's seat 110
114 bottom part of passenger's seat 111
115 backrest of passenger's seat 111
116 aisle
117 main entry door
118 dinette
119 table
120 bench
121 bench
122 bedroom
123 main bed
124 platform
125 mattress
126 retractable table
127 folding chair
128 kitchen
129 refrigerator
130 counter
131 stove
132 sink
133 sink
134 cupboard
135 television
136 bathroom
137 sink
138 toilet
139 bathtub
140 slidable wardrobe
141 slidable wall panel
142 sliding door
143 hinged door
144 retractable partition
145 slidable closet
146 cabover bed
147 mattress
148 mattress
149 entertainment center
150 storage compartment
151 retractable couch
152 couch storage compartment
153 cover of couch storage compartment
154 cover of couch storage compartment
155 cupboard
156 cupboard
157 cushion
158 cushion
159 locking hinge
160 locking hinge
161 locking hinge
162 locking hinge
163 front end wall
164 left side wall
165 right side wall
166 roof
167 end panel
168 left side panel
169 right side panel
170 top panel
171 collapsible floor
172 horizontal rack
173 horizontal rack
174 horizontal rack
175 horizontal rack
176 cross beam
177 cross beam
178 telescopic rail
179 telescopic rail
180 cross beam
181 cross beam
182 telescopic rail
183 telescopic rail
184 side awning
185 roof awning
201 driver's compartment
202 main coach section
203 dinette slide
204 bedroom slide
205 cabover compartment
206 driver's seat
207 passenger's seat
208 bottom part of driver's seat 206
209 backrest of driver's seat 206
210 bottom part of passenger's seat 207
211 backrest of passenger's seat 207
212 dinette
213 bedroom
214 main bed
215 platform
216 mattress
217 rear end panel
218 retractable table
219 folding chair
220 kitchen
221 refrigerator
222 counter
223 stove
224 sink
225 sink
226 television
227 bathroom
228 shower stall
229 retractable sink
230 toilet
231 slidable wardrobe
232 front end of wardrobe 231
233 slidable closet
234 cabover bed
235 mattress
236 mattress
237 mattress
238 cross beam
239 cross beam
240 telescopic rail
241 telescopic rail
242 cross beam
243 cross beam
244 telescopic rail
245 telescopic rail
301 driver's compartment
302 main coach section
303 dinette slide
304 bedroom slide
305 driver's seat
306 passenger's seat
307 bottom part of driver's seat 305
308 backrest of driver's seat 305
309 bottom part of passenger's seat 306
310 backrest of passenger's seat 306
311 bedroom
312 kitchen
313 bathroom
314 sink
315 toilet
316 shower stall
317 slidable wardrobe
318 retractable couch
319 cushion
320 cushion
321 supporting beam
322 first end of supporting beam
323 second end of supporting beam
324 middle section of supporting beam
325 locking hinge
326 locking hinge
327 brace
328 brace
329 first supporting post
330 second supporting post
401 dinette slide
402 bedroom slide
403 dinette
404 bedroom
405 main bed
406 kitchen
407 counter
408 stove
409 sink
410 sink
411 refrigerator
412 bathroom
413 toilet
414 shower stall
415 pivotally movable wardrobe
416 partition
417 sliding door
418 retractable partition
419 retractable couch
501 dinette slide
502 kitchen
503 bathroom
504 retractable couch
601 dinette slide
602 corner bed
603 retractable couch

### DETAILED DESCRIPTION

### First Embodiment

### FIGS. 1-15

FIGS. 1-13 show a motor home according to the first embodiment. The motor home is approximately 6.4 m (21 ft.) long, 2.6 m (8.5 ft.) wide and 3.1 m (10.2 ft.) tall in its most compact configuration. This embodiment is characterized by a slidable wardrobe 140, a slidable closet 145, and a retractable couch 151. Slidable wardrobe 140 and slidable closet 145 are located in the rear section of the vehicle. Retractable couch 151 is located in the front section and is stored under a main floor 107 when not in use.

### Overall Description

### FIGS. 1-13

The first embodiment includes a driver's compartment 101, a main coach section 102, a dinette slide 103, and a bedroom slide 104. Main coach section 102 includes a cabover compartment 105 which is located above driver's compartment 101. Dinette slide 103 is shown in its retracted position in FIG. 10 and is shown in its extended position in FIGS. 1, 5, 11, and 12. Bedroom slide 104 is shown in its retracted position in FIGS. 2, 4, 6, and 10 and is shown in its extended position in FIGS. 1, 3, 5, 7, 8, 11, and 12.

The floor 106 of driver's compartment 101 is positioned substantially lower than the main floor 107 of main coach section 102. Driver's compartment 101 has a left side door 108 and a right side door 109. It contains a driver's seat 110 and a passenger's seat 111. Driver's seat 110 includes a bottom part 112 and a backrest 113. Passenger's seat 111 includes a bottom part 114 and a backrest 115. Backrests 113 and 115 can be tilted forward in the usual manner. An aisle 116 connects main coach section 102 to the front end of driver's compartment 101. A main entry door 117 is provided on the right side of main coach section 102.

Dinette slide 103 can be extended by approximately 0.7 m (2.3 ft.) to increase the amount of space inside the vehicle. It contains a dinette 118 which includes a retractable dining table 119 and two benches 120 and 121. Dinette 118 is convertible into a bed in the usual manner.

Bedroom slide 104 can be extended by approximately 1.2 m (3.9 ft.) to create a bedroom 122. Bedroom 122 contains a main bed 123 which includes a platform 124 and a mattress 125. Main bed 123 is shown in its extended or lowered position in FIGS. 1, 8, 12, and 13 and is shown in its retracted position in FIGS. 6, 7, 9, 10, and 11. With bedroom slide 104 extended and main bed 123 in its retracted position, bedroom 122 may be used as a walk-in den or an office as shown in FIG. 11. A retractable table 126 and a folding chair 127 are provided inside bedroom 122. Alternatively, bedroom 122 may be used as a dressing room, a children's play room or an exercise room.

### Kitchen and Bathroom Arrangements

### FIGS. 1, 6-12

A kitchen 128 is provided on the right side of the vehicle. Kitchen fixtures include a refrigerator 129, a counter 130, a stove 131, two sinks 132 and 133, and a cupboard 134. A television 135 is positioned on top of refrigerator 129. A flat-panel television may be installed on the wall aft of dinette slide 103.

A bathroom 136 is provided on the left side of the vehicle. Bathroom fixtures include a sink 137, a toilet 138, and a bathtub 139.

A movable storage container is also provided on the left side of the vehicle in the form of a slidable wardrobe 140. It can be moved between a first position above bathtub 139 inside bathroom 136 and a second position inside bedroom 122 when bedroom slide 104 is in its extended position. Slidable wardrobe 140 is shown positioned inside bathroom 136 in FIGS. 6 and 10, and is shown positioned inside bedroom 122 in FIGS. 1, 7, 11, and 12. Slidable wardrobe 140 may include a set of drawers or shelves in the usual manner. A slidable wall panel 141 is provided at the rear end of bathroom 136. It can be moved towards the right side of the vehicle to create an opening for slidable wardrobe 140 to move through. An electric motor may be used for moving slidable wardrobe 140.

A sliding door 142 separates bathroom 136 from kitchen 128. A hinged door 143 and a retractable partition 144 separate the rear section of the vehicle from the middle section so that the rear section may serve as an enclosed walk-in bedroom as shown in FIG. 12. Retractable partition 144 is pivotally attached to cupboard 134 and may be moved between its retracted position (shown in FIGS. 1 and 9) and its extended position (shown in FIGS. 8 and 12). When sink 133 is not in use, a sink cover (not shown) may be placed over it to increase the amount of counter space in the usual manner.

A slidable closet 145 is provided on the right side of the vehicle. When bedroom slide 104 is in its retracted position, slidable closet 145 is positioned above counter 130 and sink 133 as shown in FIG. 10. When bedroom slide 104 is in its extended position, slidable closet 145 may be positioned inside bedroom 122 as shown in FIGS. 1, 8, 11, and 12. Slidable closet 145 is positioned at a sufficient height to allow the occupants to place their feet under it while sleeping on bed 123.

### Cabover Bed and Retractable Couch Arrangements

### FIGS. 1, 6-12

Cabover compartment 105 contains a cabover bed 146 which includes two mattresses 147 and 148. When cabover bed 146 is used for sleeping, mattress 148 is positioned next to mattress 147 as shown in FIGS. 8, 9, and 12. A ladder may be used for accessing cabover bed 146 in the usual manner. Mattress 148 may be positioned on top of mattress 147 as shown in FIGS. 1, 6, and 7. An entertainment center 149 and a storage compartment 150 are provided on the right side of cabover compartment 105.

A retractable couch 151 is provided for use when the motor home is not being driven. With backrests 113 and 115 tilted forward, couch 151 can be extended over driver's seat 110 and passenger's seat 111 as shown in FIGS. 1, 7, 8, 9, and 11. In some cases driver's seat 110 and passenger's seat 111 may have to be slid forward to make room for couch 151 to be fully extended. A couch storage compartment 152 is provided under main floor 107 for storing couch 151 while the vehicle is being driven. Couch storage compartment 152 has covers 153 and 154 which may be opened and closed manually. The positioning of main entry door 117 and dinette slide 103 near the front end of main floor 107 makes it possible for couch 151 to be moved in and out of couch storage compartment 152 whenever dinette slide 103 is in its extended position. When couch 151 is in its extended in-use position as shown in FIGS. 1, 7, 8, 9, and 11, it is accessible from main coach section 102 but blocks aisle 116 and obstructs the use of driver's seat 110 and passenger's seat 111. However, the occupants can always enter and exit main coach section 102 through main entry door 117. Cupboards 155 and 156 are provided for holding small items such as drinks, snacks, books, magazines and stationery. Taller cupboards may be provided to substantially increase the amount of storage space but they will also reduce the amount of open space inside the vehicle.

### Detailed Description of Retractable Couch 151

### FIGS. 14 and 15

As shown in FIGS. 14 and 15A-15D, cushions 157 and 158 form the bottom part and the back of couch 151, respectively. Cushions 157 and 158 are pivotally connected to each other by means of locking hinges 159 and 160. Cushion 157 is also pivotally connected to main floor 107 by means of locking hinges 161 and 162. FIG. 15A shows couch 151 in its storage position inside couch storage compartment 152. FIGS. 15B and 15C show couch 151 in its intermediate positions while being extended. FIG. 15D shows couch 151 in its fully extended position.

Electric motors may be used for extending and retracting couch 151, and for opening and closing covers 153 and 154 of couch storage compartment 152. Such motors can also be used for sliding driver's seat 110 and passenger's seat 111 forward and backward, and for moving backrests 113 and 115. Thus the whole process of getting couch 151 ready for use or putting it out of the way can be accomplished with a single push of a button.

### Detailed Description of Bedroom Slide 104

### FIGS. 1-13

Main coach section 102 has a front end wall 163, a left side wall 164, a right side wall 165, and a roof 166. Bedroom slide 104 includes an end panel 167, a left side panel 168, a right side panel 169, a top panel 170, and a collapsible floor 171. Unlike with most conventional slides, such as dinette slide 103, which retract into the interior of the vehicle, left side panel 168, right side panel 169, and top panel 170 remain on the exterior of the vehicle as bedroom slide 104 is retracted. Collapsible floor 171 can be folded in the middle as shown in FIG. 9. When bedroom slide 104 is in its fully retracted position, collapsible floor 171 is stored in an upright or vertical position adjacent to main bed 123 as shown in FIGS. 6 and 10. When bedroom slide 104 is fully extended, collapsible floor 171 is positioned slightly higher than main floor 107 as shown in FIGS. 7 and 8 so that a small towed vehicle may remain attached to the rear end of the motor home.

Rack-and-pinion systems are used for extending and retracting bedroom slide 104. Horizontal racks 172 and 173 are attached to the top and bottom parts of left side panel 168 in the respective order. Similarly, horizontal racks 174 and 175 are attached to the top and bottom parts of right side panel 169. Rack-and-pinion systems are already widely used for moving slides in conventional recreational vehicles so that it is not necessary to show the details in the drawings.

### Detailed Description of Slidable Wardrobe 140

### FIGS. 1; 6, 7, 10-13

Referring to FIGS. 1, 6, 7, and 13, slidable wardrobe 140 is suspended from two cross beams 176 and 177 which are slidably movable along telescopic rails 178 and 179 so that wardrobe 140 may be positioned either inside bathroom 136 or inside bedroom 122 when bedroom slide 104 is in its extended position. Telescopic rails 178 and 179 are attached to the lower surface of roof 166 inside bathroom 136 with the rear ends mounted to end panel 167 so that they telescope outwards as bedroom slide 104 is extended. Wardrobe 140 is also slidably movable with respect to cross beams 176 and 177 in the horizontal direction perpendicular to the length of the vehicle so that it can be pushed towards left side panel 168 to create more open space inside bedroom 122. A latch or any other suitable fastener may be provided for securing wardrobe 140 to left side wall 164 or left side panel 168.

### Detailed Description of Slidable Closet 145

### FIGS. 1, 8-13

Referring to FIGS. 1, 8, 9, and 13, slidable closet 145 is suspended from cross beams 180 and 181 which are slidably movable along telescopic rails 182 and 183 so that closet 145 may be positioned either above kitchen counter 130 or inside bedroom 122 when bedroom slide 104 is in its extended position. Closet 145 is also slidably movable with respect to cross beams 180 and 181 in the horizontal direction perpendicular to the length of the vehicle so that it can be pushed towards right side panel 169 to create more open space inside bedroom 122. A latch or any other suitable fastener may be provided for securing closet 145 to right side wall 165 or right side panel 169.

### Additional Accessories

As shown in FIGS. 2, 3, 4, and 5, an optional side awning 184 is attached to right side wall 165. Side awning 184 is approximately 3.7 m (12 ft.) in length and may have lateral arms which are operated by electric motors. Since this type of awning is widely available, no detailed description is necessary. An optional roof awning 185 is also provided on top of roof 166 to prevent dust and leaves from getting under top panel 170.

Stabilizer jacks may be attached to the chassis of the motor home to increase its stability when bedroom slide 104 is in its extended position. Additional jacks or retractable wheels may be attached to the bottom part of bedroom slide 104.

### Ramifications

Several other modifications can be made to the motor home of the first embodiment. For example, bedroom slide 104 can be replaced by a retractable sleeping compartment with soft sidewalls similar to those found on conventional trailers; a kitchen slide containing refrigerator 129, counter 130, stove 131, sinks 132 and 133, and cupboard 134 can be provided on the right side of the vehicle; hinged door 143 can be replaced by an accordion door; a curtain can be installed in driver's compartment 101 so that it can be extended around the ends and the back of couch 151 for added privacy; a retractable couch with inflatable or removable cushions can be used in place of couch 151; collapsible floor 171 can be replaced by a non-collapsible platform hinged at one end; bedroom slide 104 can be operated by a hydraulic system or a rack-and-pinion system positioned under main floor 107; a larger bedroom slide or a longer chassis can be used so that more walking space can be provided adjacent to bed 123, etc.

The dimensions, materials, construction, and assembly of these motor homes and their components will be readily apparent to those skilled in the art. For example, aluminum, steel or wood framing may be combined with aluminum or fiberglass panels to make the motor home's body. Alternatively, the motor home may have a molded fiberglass body with no framing. The retractable couch may include a metal frame and two or more foam cushions with imitation-leather or fabric covers. The movable wardrobe and movable closet may be made of wood, plastic, fiberglass or any other suitable material.

### Operation and Advantages

Although the motor home of the first embodiment may be driven with bedroom slide 104 in its extended position, it is preferably driven in its most compact configuration as shown in FIGS. 2, 4, 6, and 10 with dinette slide 103 and bedroom slide 104 in their retracted positions and couch 151 stored in couch storage compartment 152. In this configuration the motor home of the first embodiment has a floor plan similar to that of a conventional motor home without a bedroom and a couch. Main entry door 117, dinette 118, refrigerator 129, stove 131, sink 132, television 135, bathroom sink 137, toilet 138, slidable wardrobe 140, slidable closet 145, and entertainment center 149 remain easily accessible in this configuration. Since dinette 118 can seat up to four people, the motor home may be used to transport up to six people. Although bathtub 139 is not accessible in this configuration, it is unlikely that any of the occupants would want to take a bath while the vehicle is being driven.

While the motor home is not being driven, dinette slide 103 and bedroom slide 104 may be kept in their extended positions as shown in FIGS. 1, 3, 5, 7, 8, 11, and 12. During the daytime, main bed 123 may be kept in its retracted position and couch 151 may be kept in its extended position as shown in FIGS. 7 and 11. During the night time, both main bed 123 and cabover bed 146 may be arranged for sleeping as shown in FIGS. 8 and 12. With bedroom slide 104 in its extended position, slidable wardrobe 140 and slidable closet 145 may be easily moved forward and backward as convenient.

### DETAILED DESCRIPTION

### Second Embodiment

### FIGS. 16-27

FIGS. 16-27 show a motor home of the second embodiment which is approximately 5.9 m (19.4 ft.) long, 2.4 m (7.9 ft.) wide and 3.3 m (10.8 ft.) tall in its most compact configuration. This embodiment is approximately 0.5 m (1.6 ft.) shorter and 0.2 m (7 inches) narrower than the motor home of the first embodiment. It is also shorter than some of the pickup trucks from the leading manufactures. The motor home of the second embodiment is characterized by a main bed 214 which can be retracted vertically upwards, and a cabover bed 234 which can be lowered and converted into a couch.

### Overall Description

### FIGS. 16-27

The motor home of the second embodiment includes a driver's compartment 201, a main coach section 202, a dinette slide 203, and a bedroom slide 204. Main coach section 202 includes a cabover compartment 205 which is located above driver's compartment 201. Driver's compartment 201 contains a driver's seat 206 and a passenger's seat 207. Driver's seat 206 includes a bottom part 208 and a backrest 209. Passenger's seat 207 includes a bottom part 210 and a backrest 211.

Dinette slide 203 contains a dinette 212 and can be extended by approximately 0.7 m (2.3 ft.) to increase the amount of space inside the vehicle. Bedroom slide 204 can be extended by approximately 1.3 m (4.3 ft.) to create a bedroom 213. A main bed 214 is provided inside bedroom slide 204 and includes a platform 215 and a mattress 216. Main bed 214 can be retracted vertically upwards with the use of electric motors. Main bed 214 is shown in its retracted or raised position in FIGS. 20, 22, and 23 and is shown in its lowered position in FIGS. 21, 26, and 27. Bedroom slide 204 has a rear end panel 217 with a retractable table 218 attached to it. A folding chair 219 is also provided so that bedroom 213 may be used as an office as shown in FIG. 25.

A kitchen 220 is provided on the right side of the vehicle and includes a refrigerator 221, a counter 222, a stove 223, and sinks 224 and 225. A television 226 is provided on top of refrigerator 221.

A bathroom 227 is located on the left side of the vehicle and contains a shower stall 228, a retractable sink 229, and a toilet 230. A slidable wardrobe 231 is also provided and may be moved between a first position inside bathroom 227 and a second position inside bedroom 213 when bedroom slide 204 is in its extended position. Slidable wardrobe 231 is shown positioned inside bathroom 227 in FIG. 24 and is shown positioned inside bedroom 213 in FIGS. 21, 25, and 26. When slidable wardrobe 231 is positioned inside bedroom 213 as shown in FIG. 25, its front end 232 becomes a part of the rear end wall of bathroom 227. As shown in FIG. 21, slidable wardrobe 231 is positioned high enough above bed 214 to allow the occupants to place their feet underneath it while sleeping on bed 214.

Similarly a slidable closet 233 is provided on the right side of the vehicle. It is shown positioned above counter 222 and sink 225 in FIGS. 23, 24, and 26, and is shown positioned inside bedroom 213 in FIGS. 22 and 25.

As shown in FIGS. 21 and 26, the motor home of the second embodiment is equipped with a cabover bed 234 which includes three connected mattresses 235, 236, and 237. Mattress 237 may be positioned on top of mattress 236 as shown in FIG. 20. With backrests 209 and 211 tilted forward, mattresses 236 and 237 may be lowered to form a couch as shown in FIGS. 22, 23, and 25.

Slidable wardrobe 231 is slidably attached to cross beams 238 and 239 which are movable along telescopic rails 240 and 241 as shown in FIGS. 21 and 27. Similarly slidable closet 233 is slidably attached to cross beams 242 and 243 which are movable along telescopic rails 244 and 245 as shown in FIGS. 22, 23, and 27. Wardrobe 231 and closet 233 can be moved in the same way as wardrobe 140 and closet 145 of the first embodiment but telescopic rails 240, 241, 244 and 245 must be detachable from rear end panel 217 so that main bed 214 may be raised or lowered when bedroom slide 204 is in its extended position.

### Operation and Advantages

With backrests 209 and 211 tilted forward, mattresses 236 and 237 may be lowered to form a couch as indicated above. This is done by first placing mattress 237 on top of mattress 236 as shown in FIG. 20 and then sliding bed 234 rearward until mattresses 236 and 237 can be lowered into the position shown in FIGS. 22, 23, and 25. Unlike retractable couch 151 of the first embodiment, this arrangement does not require a couch storage compartment and enables the motor home to be made even shorter.

### DETAILED DESCRIPTION

### Third Embodiment

### FIGS. 28-31

FIGS. 28 and 29 show the floor plan of a motor home of the third embodiment which is approximately 6.2 m (20.3 ft.) long and 2.3 m (7.5 ft.) wide in its most compact configuration. This embodiment is characterized by a retractable couch 318 which can be placed in a storage position on one end when not in use.

### Overall Description

### FIGS. 28-31

The motor home of the third embodiment includes a driver's compartment 301, a main coach section 302, a dinette slide 303, and a bedroom slide 304. Driver's compartment 301 contains a driver's seat 305 and passenger's seat 306. Driver's seat 305 includes a bottom part 307 and a backrest 308. Passenger's seat 306 includes a bottom part 309 and a backrest 310.

Dinette slide 303 may be extended by approximately 0.7 m (2.3 ft.) to increase the amount of space inside the vehicle. Bedroom slide 304 is similar to bedroom slide 204 of the second embodiment and may be extended by approximately 1.3 m (4.3 ft.) to create a bedroom 311.

The motor home of the third embodiment has a kitchen 312 which is similar to kitchen 220 of the second embodiment. Bathroom 313 contains a sink 314, a toilet 315, and a shower stall 316. A slidable wardrobe 317 is also provided and can be moved between a first position above sink 314 and shower stall 316 inside bathroom 313 and a second position inside bedroom 311 when bedroom slide 304 is in its extended position. When slidable wardrobe 317 is stored inside bathroom 313 as shown in FIG. 28, it only covers one end of shower stall 316 so that the other end may be used for hand washing.

A retractable couch 318 is also provided and can be retracted and stored on one end behind passenger seat 306 as shown in FIG. 28. This arrangement does not take up additional space under the main floor but makes the entry way narrower when retractable couch 318 is in its storage position.

As shown in FIGS. 30A-30D and 31A-31B, couch 318 includes cushions 319 and 320, and a supporting beam 321. Supporting beam 321 includes a first end 322, a second end 323, and a middle section 324. Cushions 319 and 320 are connected to each other by means of locking hinges 325 and 326. Cushion 319 is pivotally attached to supporting beam 321 by means of braces 327 and 328. First end 322 of supporting beam 321 is pivotally attached to a first supporting post 329 which is positioned behind passenger's seat 306. Second end 323 of supporting beam 321 is removably attached to a second supporting post 330 which is positioned behind driver's seat 305.

### Operation and Advantages

The motor home of the third embodiment is preferably driven with dinette slide 303 and bedroom slide 304 in their retracted positions as shown in FIG. 28 and with retractable couch 318 in its storage position as shown in FIGS. 28, 30A, and 31A. When the motor home is not being driven and dinette slide 303 is in its extended position, retractable couch 318 may be placed in its extended position as shown in FIGS. 29 and 30D.

FIGS. 30A-30D and 31A-31B show the steps involved in deploying retractable couch 318. The first step is to pivot retractable couch 318 with supporting beam 321 by 90 degrees about first end 322 of supporting beam 321 in the direction shown by the arrow in FIG. 31A. This puts retractable couch 318 in the position shown in FIGS. 30B and 31B. The second step is to pivot retractable couch 318 forward by 90 degrees about supporting beam 321 to put it in the position shown in FIG. 30C. The final step is to raise cushion 320 into its upright position shown in FIG. 30D. This process may be reversed to put retractable couch 318 back in its storage position shown in FIGS. 28, 30A, and 31A.

A spring may be used to make it easier for retractable couch 318 to be lifted and placed in its storage position shown in FIGS. 28, 30A, and 31A. A fastener may also be provided for securing couch 318 in its storage position. Electric motors may be used for extending and retracting couch 318.

An advantage that retractable couch 318 has over retractable couch 151 of the first embodiment is that it does not require a storage compartment. Retractable couch 318 can also be made more comfortable than the couch formed by mattresses 236 and 237 of the second embodiment.

### DETAILED DESCRIPTION

### Fourth Embodiment

### FIGS. 32 and 33

FIGS. 32 and 33 show the floor plan of a motor home of the fourth embodiment which is approximately 6.3 m (20.7 ft.) long and 2.6 m (8.5 ft.) wide in its most compact configuration. This embodiment is characterized by a pivotally movable wardrobe 415 which can be moved between a first position inside a bathroom 412 and a second position inside a bedroom 404.

### Overall Description

### FIGS. 32 and 33

The motor home of the fourth embodiment is equipped with a dinette slide 401 on the left side and a bedroom slide 402 at the rear end. Dinette slide 401 contains a dinette 403 and may be extended by approximately 0.7 m (2.3 ft.) to increase the amount of space inside the vehicle. Bedroom slide 402 may be extended by approximately 1.2 m (3.9 ft.) to create a bedroom 404. Bedroom slide 402 contains a main bed 405 which is similar to main bed 123 of the first embodiment.

A kitchen 406 is provided on the right side of the vehicle and includes a counter 407, a stove 408, two sinks 409 and 410, and a refrigerator 411. Refrigerator 411 is positioned under stove 408.

A bathroom 412 is provided on the left side of the vehicle. It contains a toilet 413 and a shower stall 414. A sink is not provided inside bathroom 412 but kitchen sink 410 may be used as a vanity sink.

A pivotally movable wardrobe 415 is provided in this embodiment instead of a slidably movable wardrobe. A partition 416 is connected by means of hinges to pivotally movable wardrobe 415.

A sliding door 417 and a retractable partition 418 are also provided so that the rear section of the motor home may be converted into an enclosed walk-in bedroom as shown in FIG. 33.

The motor home of the fourth embodiment also includes a retractable couch 419 which is similar to retractable couch 151 of the first embodiment.

### Operation and Advantages

With bedroom slide 402 in its extended position, wardrobe 415 can be moved between a first position above shower stall 414 inside bathroom 412 and a second position inside bedroom 404. Wardrobe 415 is shown positioned inside bathroom 412 in FIG. 32 and is shown positioned inside bedroom 404 in FIG. 33. Partition 416 may be extended as shown in FIG. 33 to block the opening between bathroom 412 and bedroom 404 when wardrobe 415 is positioned inside bedroom 404.

Since wardrobe 415 does not use telescopic rails for its operation, it can be easier and less expensive to build and install than the slidably movable wardrobes and closets of the previous embodiments.

### DETAILED DESCRIPTION

### Fifth Embodiment

### FIGS. 34 and 35

FIGS. 34 and 35 show the floor plan of a motor home of the fifth embodiment which is approximately 5.9 m (19.4 ft.) long and 2.3 m (7.5 ft.) wide in its most compact configuration. This embodiment has a dinette slide 501 on the left side but does not have a bedroom slide at the rear end. A kitchen 502 and a bathroom 503 are provided in the rear section of the vehicle and are similar to kitchen 220 and bathroom 227 of the second embodiment. This embodiment also includes a retractable couch 504 which is similar to retractable couch 151 of the first embodiment.

The motor home of the fifth embodiment has an advantage of being simple and inexpensive to build.

### DETAILED DESCRIPTION

### Sixth Embodiment

### FIGS. 36 and 37

FIGS. 36 and 37 show the floor plan of a motor home of the sixth embodiment which is approximately 7 m (23 ft.) long and 2.6 m (8.5 ft.) wide in its most compact configuration. This embodiment has a dinette slide 601 on the left side but does not have a bedroom slide at the rear end. A corner bed 602 is provided and may have a large storage compartment underneath it. A retractable couch 603 is also provided and is similar to retractable couch 151 of the first embodiment.

This embodiment is longer than the previous embodiments but is substantially shorter than similarly equipped conventional motor homes with a couch, a separated dinette and a corner bed.

### CONCLUSION, RAMIFICATIONS AND SCOPE

As indicated, the space-saving features of my recreational vehicles make it possible to provide fully-equipped motor homes which are significantly shorter than conventional motor homes with similar amenities.

Since a large number of public parking spaces are approximately 6 m (20 ft.) in length, these motor homes can be parked in many more parking spaces than similarly equipped conventional motor homes which are approximately a meter longer. The shorter length of these motor homes also makes them significantly easier and safer to drive.

These motor homes also have other advantages over conventional motor homes of comparable sizes. For example, all of the embodiments described above have a couch and a separated dinette whereas similarly equipped conventional motor homes of comparable sizes are usually provided without a couch or a dinette.

The movable wardrobes and closets in the first four embodiments also make it possible for these motor homes to have more storage space than conventional motor homes of comparable sizes.

The space-saving features of these motor homes can be easily implemented using existing technologies and allow the motor homes to serve as a fully-functional recreational vehicle while being driven.

Although the description above contains many specificities, these should not be construed as limiting the scope of the embodiments but as merely providing illustrations of some of the embodiments. Those skilled in the art will envision many other modifications. For example, the retractable couch can have left and right halves which can be retracted and stored on opposite sides of the main coach section; the type of movable storage compartment shown in the first four embodiments can also be installed in other types of recreational vehicle such as a travel trailer, etc.

Thus the scope of the embodiments should be determined by the appended claims and their legal equivalents, rather than by the examples given.

1. A recreational vehicle, comprising:
an elongated wheeled enclosure having an interior;
a bathroom located in said interior and substantially defined by a plurality of bathroom walls;
an opening in a said plurality of bathroom walls;
a storage container movably attached to said interior for movements through said opening between a first position inside said bathroom and a second position within said interior outside said bathroom;
a movable wall section positioned over said opening to keep said bathroom substantially enclosed when said storage container is in said second position;
whereby the moving of said storage container from said first position to said second position increases the amount of space inside said bathroom.

2. The recreational vehicle of claim 1, further include a sleeping compartment located in said interior wherein said second position of said storage container is inside said sleeping compartment.

3. The recreational vehicle of claim 2, further including a bed positioned inside said sleeping compartment wherein said second position of said storage container is above said bed.

4. The recreational vehicle of claim 3 wherein said sleeping compartment is a substantially enclosed bedroom.

5. The recreational vehicle of claim 2 wherein said storage container is accessible from the inside of said bathroom when said storage container is in said first position and wherein said storage container is accessible from the inside of said sleeping compartment when said storage container is in said second position.

6. The recreational vehicle of claim 1 wherein said storage container is slidably attached to said interior.

7. The recreational vehicle of claim 6 wherein said storage container is movable along a rail attached to said interior.

8. The recreational vehicle of claim 6 wherein said storage container is suspended from a rail attached to said interior.

9. The recreational vehicle of claim 6 wherein said storage container is suspended from two rails attached to said interior.

10. The recreational vehicle of claim 1 wherein said storage container is pivotally attached to said interior.

11. The recreational vehicle of claim 1 wherein said movable wall section comprises a movable wall panel.

12. The recreational vehicle of claim 11 wherein said movable wall panel is also positioned over said opening when said storage container is in said first position;

13. The recreational vehicle of claim 1 wherein said movable wall section comprises one end of said storage container.

14. The recreational vehicle of claim 1, further including a bathroom fixture positioned inside said bathroom wherein said bathroom fixture is used for supporting and washing a human body and wherein said first position of said storage container is above said bathroom fixture.

15. The recreational vehicle of claim 14 wherein said bathroom fixture is a bathtub.

16. The recreational vehicle of claim 14 wherein said bathroom fixture is a shower stall.

17. The recreational vehicle of claim 14, further including a toilet positioned inside said bathroom.

18. The recreational vehicle of claim 17, further including a sink positioned inside said bathroom.

19. The recreational vehicle of claim 18 wherein said toilet and said sink are accessible whether said storage container is in said first position or said second position and wherein the moving of said storage container from said first position to said second position allows access to said bathroom fixture.

20. The recreational vehicle of claim 1, further including a bathroom door for providing human access to said bathroom wherein said opening and said bathroom door comprise distinct openings in said plurality of bathroom walls.

21. The recreational vehicle of claim 20 wherein said opening and said bathroom door comprise separate openings in said plurality of bathroom walls.

22. The recreational vehicle of claim 20 wherein said plurality of bathroom walls include a bathroom door panel.

23. The recreational vehicle of claim 1 wherein said storage container is a wardrobe.

24. The recreational vehicle of claim 1 wherein said storage container is a box-shaped cabinet.

25. A recreational vehicle, comprising:
an elongated wheeled enclosure having an interior;
a bathroom located in said interior and substantially defined by a plurality of bathroom walls;
a bathroom fixture positioned inside said bathroom;
an opening in said plurality of bathroom walls;
a sleeping compartment located in said interior adjacent to said bathroom;
a wardrobe movably attached to said interior for movements through said opening between a first position inside said bathroom and a second position inside said sleeping compartment;
a movable wall section positioned to cover said opening to keep said bathroom substantially enclosed when said wardrobe is in said second position;
whereby the moving of said wardrobe from said first position to said second position allows access to said bathroom fixture and increases the amount of space inside said bathroom.

26. The recreational vehicle of claim 25 wherein said bathroom fixture is a bathtub.

27. The recreational vehicle of claim 25 wherein said bathroom fixture is a shower stall.

28. A method for providing a space-saving storage container in a recreational vehicle, comprising:
providing a recreational vehicle comprising an elongated wheeled enclosure with an interior;
providing a bathroom inside said interior wherein said bathroom is substantially defined by a plurality of bathroom walls;
providing an opening in said plurality of bathroom walls;
installing a storage container inside said interior wherein said storage container is movably attached to said interior for movements through said opening between a first position inside said bathroom and a second position within said interior outside said bathroom;
positioning a movable wall section over said opening to keep said bathroom substantially enclosed when said storage container is in said second position;
whereby the moving of said storage container from said first position to said second position increases the amount of space inside said bathroom.

29. The recreational vehicle of claim 28, further including a sleeping compartment wherein said second position of said storage container is inside said sleeping compartment.

30. The recreational vehicle of claim 29, further including a bathtub wherein said first position of said storage container is above said bathtub.

31. The recreational vehicle of claim 29, further including a shower stall wherein said first position of said storage container is above said shower stall.
